(19) United States
(12) Patent Application Publication
(10) Pub. No.: US 2025/0319968 A1
(43) Pub. Date: Oct. 16, 2025

(54) UNMANNED AERIAL VEHICLE

(71) Applicant: Kubota Corporation, Osaka (JP)

(72) Inventor: Naohiro ISHIKAWA, Sakai-shi (JP)

(21) Appl. No.: 19/248,011

(22) Filed: Jun. 24, 2025

Related U.S. Application Data
(63) Continuation of application No. PCT/JP2022/048158, filed on Dec. 27, 2022.

(51) Int. Cl. B64D 1/18; B64U 10/14; B64U 101/40

(52) U.S. Cl. CPC B64D 1/18; B64U 10/14; B64U 2101/40

(57) ABSTRACT

An unmanned aerial vehicle includes a plurality of rotors, a main body supporting the plurality of rotors, a tank that accommodates agricultural materials, and a conveyor provided on the tank to transport the agricultural materials toward the tank. The conveyor has elasticity and/or flexibility.

### CROSS REFERENCE TO RELATED APPLICATIONS

This application is a Continuation Application of PCT Application No. PCT/JP2022/048158 filed on Dec. 27, 2022. The entire contents of this application are hereby incorporated herein by reference.

### BACKGROUND OF THE INVENTION

### 1. Field of the Invention

The present disclosure relates to unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

In agricultural applications, systems have been developed to supply pesticides or electric power to drones for field application. Japanese Patent Application Publication No. 2021-75277 describes such a system. The system includes a base station where drones can land or dock, and a holding tank that stores pesticides.

### SUMMARY OF THE INVENTION

There is a need for improved technology to supply liquid agents such as herbicides or insecticides, and fuels from a supply station to an unmanned aerial vehicle.

Example embodiments of the present disclosure provide unmanned aerial vehicles that each enable smooth supply of liquid agents such as herbicides or insecticides, and fuels from a supply station to the unmanned aerial vehicle.

In a non-limiting example embodiment, an unmanned aerial vehicle of the present disclosure includes a plurality of rotors, a main body supporting the plurality of rotors, a tank that accommodates agricultural materials, and a conveyor provided on the tank to transport the agricultural materials toward the tank, wherein the conveyor has elasticity and/or flexibility.

According to example embodiments of the present disclosure, unmanned aerial vehicles each enable smooth supply of liquid agents such as herbicides or insecticides, and fuels from a supply station to the unmanned aerial vehicle.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3 is a side view schematically showing one example of a basic configuration of a multicopter including a tank and a conveyor.

FIG. 4 is an enlarged view of the connector between the tank and the conveyor.

FIG. 5 is a block diagram showing a basic configuration example of a multicopter including a tank and a conveyor.

FIG. 6 is a side view schematically showing another example of a basic configuration of a multicopter including a tank and a conveyor.

FIG. 7 is a diagram schematically showing a multicopter connected to a supply station by a conveyor.

FIG. 8A is a schematic diagram showing a multicopter replenishing materials while hovering.

FIG. 8B is a schematic diagram showing another way a multicopter replenishes materials while hovering.

FIG. 9 is a block diagram showing an example of hardware configuration of a controller.

FIG. 10 is a schematic diagram showing an example where a multicopter, an agricultural machine, a server, and a terminal device are connected via a communication network.

### DETAILED DESCRIPTION OF THE EXAMPLE EMBODIMENTS

Unmanned aerial vehicles include a plurality of rotors and include a rotation driver to rotate the rotors (hereinafter referred to as “propellers”). Hereinafter, such an unmanned aerial vehicle is referred to as a “multicopter”.

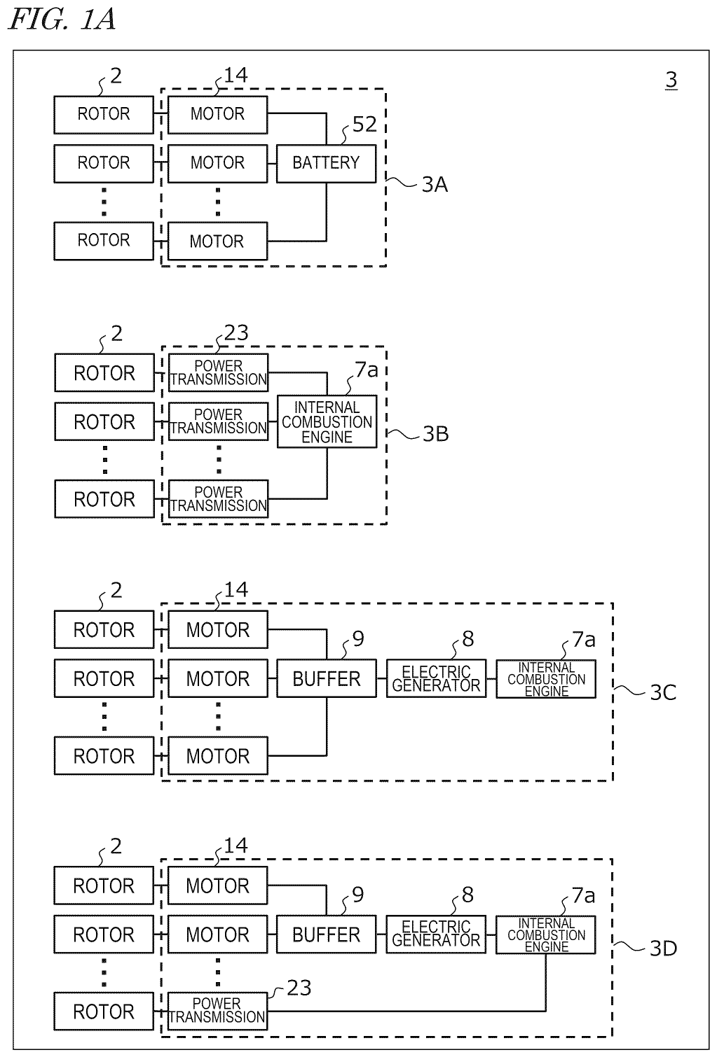

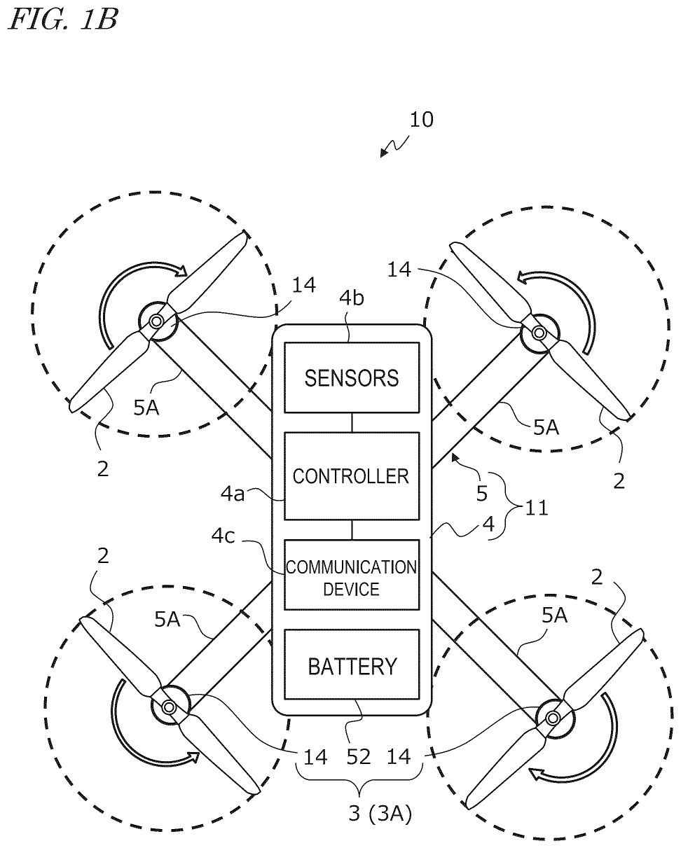

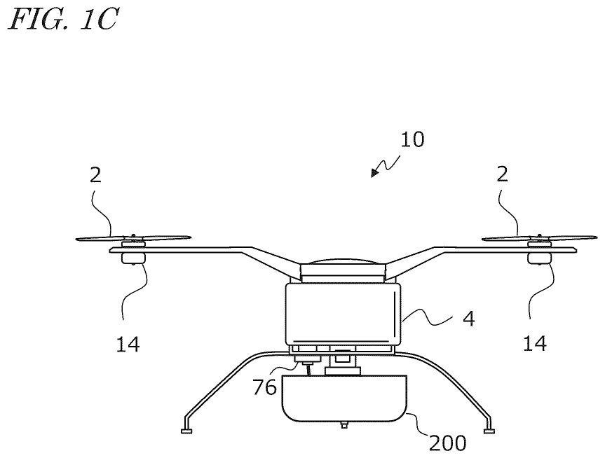

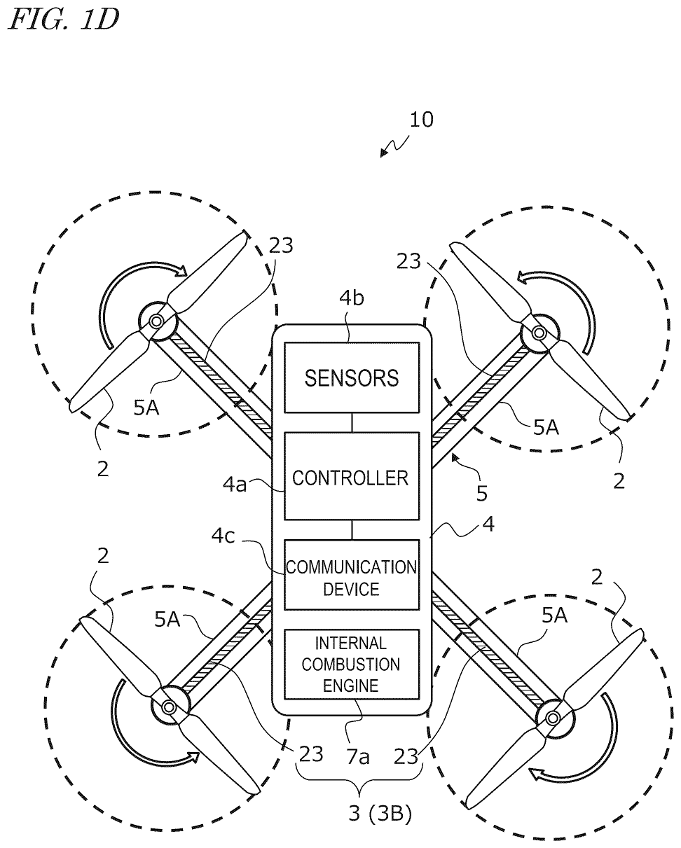

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, and a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motors 14. In the fourth rotation driver 3D, since mechanical energy generated by internal combustion engine 7a can be utilized for rotor rotation without conversion to electrical energy, energy utilization efficiency can be enhanced. This type of driver is called “parallel hybrid driver”.

FIG. 1B is a plan view schematically showing a basic configuration example of multicopter 10. The configuration example in FIG. 1B includes the first rotation driver 3A shown in FIG. 1A as rotation driver 3. That is, in this example, rotation driver 3 (3A) includes motors 14 and a battery 52. FIG. 1C is a side view schematically showing the multicopter.

The multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably with a plurality of arms 5A extending outward from the central portion. The motors 14 that rotate rotors 2 are provided near the ends of each arm 5A.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may be configured or programmed to include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, an angular velocity sensor, a geomagnetic sensor, an atmospheric pressure sensor, an altitude sensor, a temperature sensor, a flow sensor, an imaging device, a laser sensor, an ultrasonic sensor, an obstacle contact sensor, and a GNSS (Global Navigation Satellite System) receiver. The acceleration sensor and angular velocity sensor may be mounted on the main body 4 as components of an IMU (Inertial Measurement Unit). Examples of laser sensors may include a laser range finder used for measuring distance to the ground, and 2D or 3D LiDAR.

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per rotation may be called “main rotors” and the rotors 2 that generate relatively small thrust per rotation may be called “sub-rotors”. In one example, main rotors may be positioned more inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid drive, the diameter of one or more rotors 2 rotated by the internal combustion engine 7a may be larger than the diameter of other rotors 2 rotated by the motors 14. In other words, the internal combustion engine 7a may be used to rotate the main rotors and the motors 14 may be used to rotate the sub-rotors. In such case, the main rotors are mainly used for generating thrust, and the sub-rotors are used for both generating thrust and attitude control. The main rotors may be called “booster rotors” and the sub-rotors may be called “attitude control rotors”.

In the parallel hybrid drive, the internal combustion engine 7a is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine 7a and uses the internal combustion engine 7a for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt parallel hybrid driver or series hybrid driver to increase payload and flight duration.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “work machines” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing implement 200 connected to multicopter 10, various ground operations (agricultural work) including liquid application, granular application, fertilization, thinning, weeding, transplanting, direct seeding, and harvesting can be performed. The implement 200 may include mechanisms such as robotic hands. In that case, a single implement 200 can perform various ground operations. Additionally, if the implement 200 includes space large enough to store materials, the implement 200 can also transport agricultural materials or harvested crops over a wide area.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of implement 200 may be performed using this power. The implement 200 includes actuators such as motors that operate using power obtained from the power supply 76 of the multicopter 10. The implement 200 preferably includes a battery for storing power.

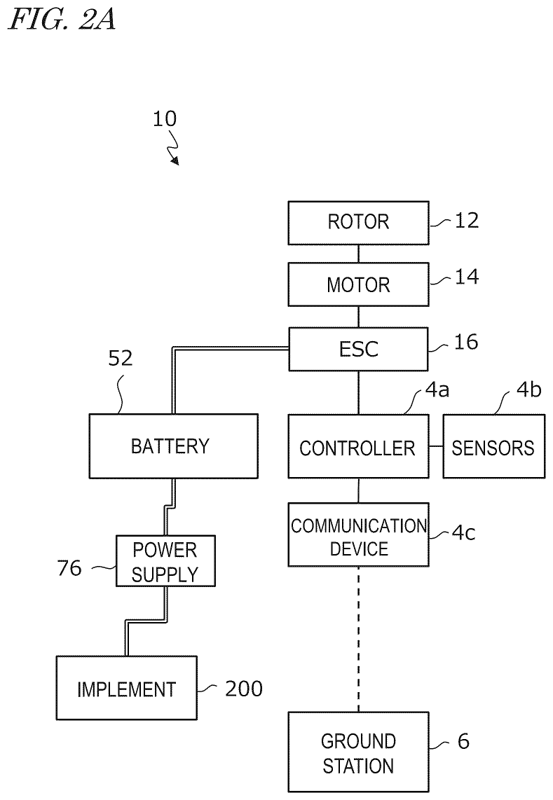

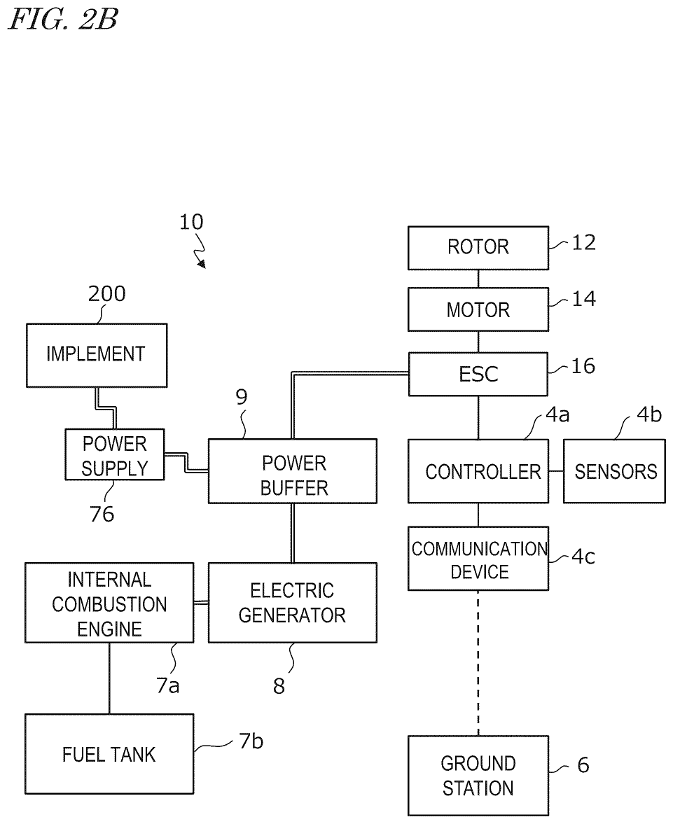

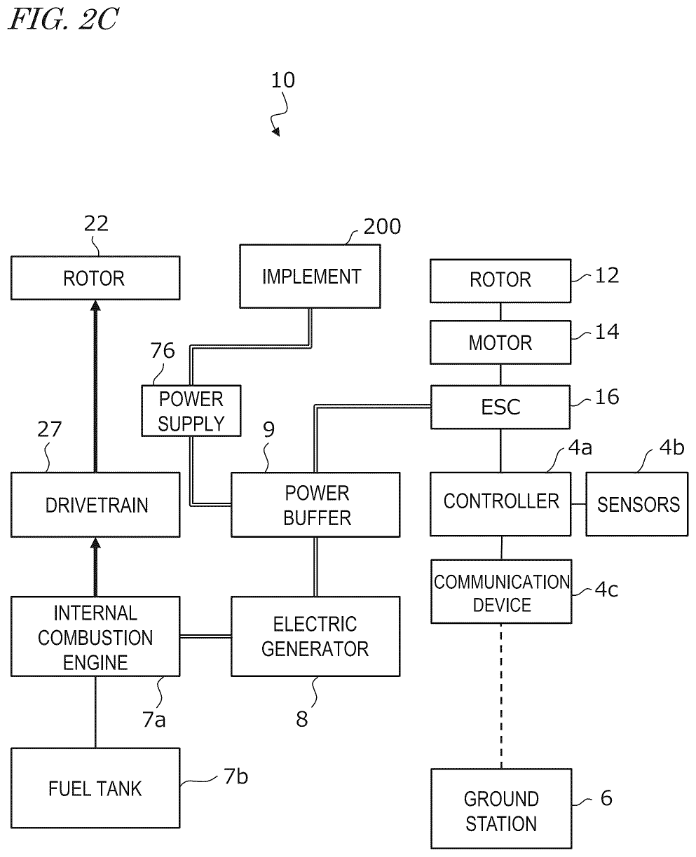

FIG. 2A is a block diagram showing a basic configuration example of a battery-driven multicopter 10. The battery-driven multicopter 10 includes a plurality of rotors 12, a plurality of motors 14 each rotating a respective one of the plurality of rotors 12, a plurality of ESCs (Electric Speed Controllers) 16 each including a motor drive circuit that drives a respective one of the plurality of motors 14, a battery 52 that supplies power to each of the motors 14 through respective ESCs 16, a controller 4a configured or programmed to control a plurality of ESCs 16 to control attitude while flying, sensors 4b, a communication device 4c, and a power supply 76 that is electrically connected to the battery 52. Rotor 12 is an example of rotor 2. Devices such as the controller 4a, sensors 4b, communication device 4c, etc., may be connected to each other through a CAN (Controller Area Network) bus to enable communication. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and they may be distributed across multiple locations. The communication device 4c may also wirelessly receive control commands from an operator's controller on the ground. The controller 4a may be configured or programmed to perform functions to automatically or autonomously execute takeoff, flight, obstacle avoidance, and landing operations based on sensor data obtained from the sensors 4b.

The controller 4a may be configured or programmed to communicate with the implement 200 connected to power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless means.

FIG. 2B is a block diagram showing a basic configuration example of a series hybrid driver type multicopter 10. Like the battery-driven multicopter 10, the series hybrid driver type multicopter 10 includes a plurality of rotors 12, a plurality of motors 14, a plurality of ESCs 16, a controller 4a, sensors 4b, and a communication device 4c. The series hybrid driver type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid driver type multicopter 10. Like the series hybrid driver type multicopter 10, the parallel hybrid driver type multicopter 10 includes a plurality of rotors 12, a plurality of motors 14, a plurality of ESCs 16, a controller 4a, sensors 4b, a communication device 4c, an internal combustion engine 7a, a fuel tank 7b, an electric generator 8, a power buffer 9, and a power supply 76. The parallel hybrid driver type multicopter 10 further includes a drivetrain 27 that transmits driving force from the internal combustion engine 7a, and rotor 22 that rotates upon the receiving driving force from the internal combustion engine 7a through the drivetrain 27. Rotor 22 is an example of rotor 2. The number of rotors 22 connected to the drivetrain 27 and rotated may be one or two or more.

In the parallel hybrid driver type multicopter 10, the internal combustion engine 7a not only drives the electric generator 8 to generate power but also mechanically transmits energy to rotor 22 to rotate the rotor 22. In contrast, in the series hybrid driver type multicopter 10, all rotors 12 are rotated by electric power generated by the electric generator 8. Therefore, in the series hybrid driver type multicopter 10, if the electric generator 8 is, for example, a fuel cell, then the internal combustion engine 7a is not an essential component.

The multicopters according to example embodiments of the present disclosure may further include a tank for accommodating agricultural materials and a conveyor provided on the tank to transport agricultural materials toward the tank. The conveyor may include, for example, a flexible tube or flexible hose. For example, the conveyor extends from a multicopter hovering in the air or landed on the ground to a supply station installed on the ground, and agricultural materials are supplied from the supply station to the multicopter through the conveyor. The supply station is a source of agricultural materials, and the scale or structure of the source is arbitrary.

“Agricultural materials” means materials consumed by agricultural work performed by the multicopter in general. The agricultural materials in example embodiments of the present disclosure are granular or liquid materials. Examples of agricultural materials include liquid agents or granular agents such as herbicides or insecticides, water, fertilizers and seeds, and also include fuel consumed by internal combustion engines. Hereinafter, agricultural materials will be simply referred to as “materials”.

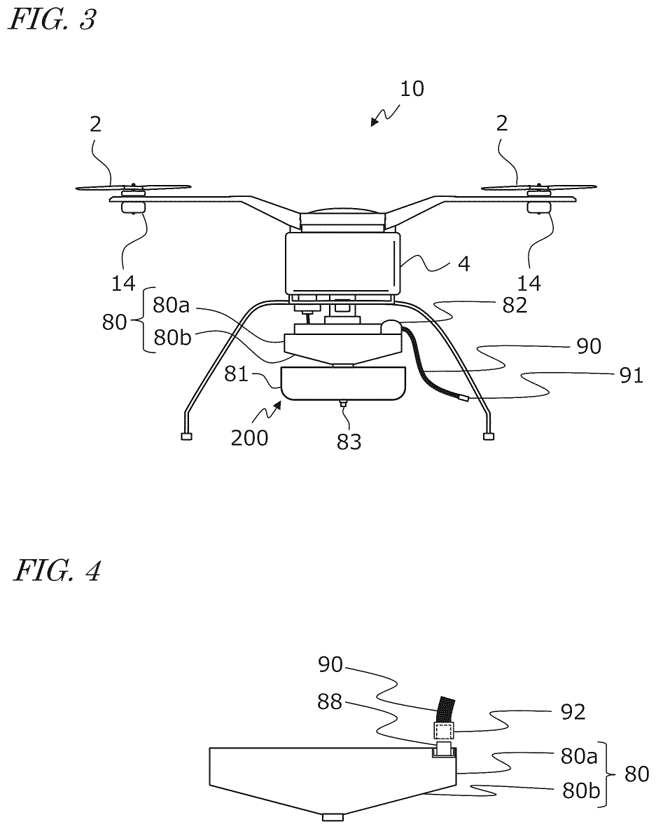

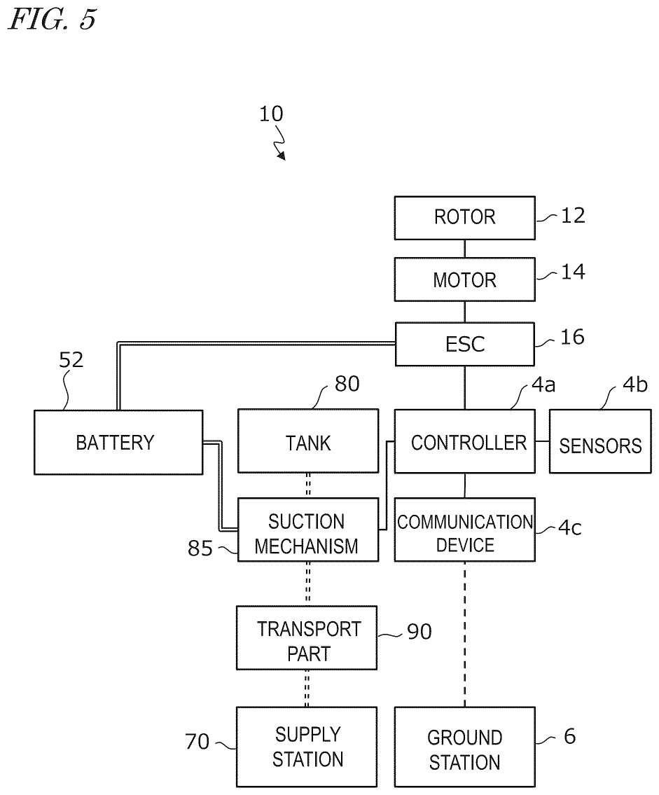

FIG. 3 is a side view schematically showing one example of a basic configuration of the multicopter 10 including a tank 80 and a conveyor 90. FIG. 4 is an enlarged view of the connector between the tank 80 and the conveyor 90. FIG. 5 is a block diagram showing a basic configuration example of the multicopter 10 including the tank 80 and the conveyor 90.

The multicopter 10 illustrated in FIG. 3 includes a tank 80, a work machine main body 81, and a conveyor 90. The multicopter 10 may further include a housing 82 that houses the conveyor 90. The implement 200 shown in the example in FIG. 3 is a spreader capable of dispersing materials such as liquid agents or granular agents onto a field or crops in the field. The tank 80 and the work machine main body 81 are components of the implement 200. In other words, the implement 200 includes the tank 80 and the work machine main body 81. The tank 80 is positioned below the main body 4. Furthermore, the work machine main body 81 is positioned below the tank 80. Thus, the main body 4, tank 80, and work machine main body 81 are arranged vertically in this order.

The tank 80 illustrated in FIG. 3 has an internal space for accommodating materials such as liquid agents or granular agents. The tank 80 includes an upper portion 80a and a lower portion 80b. The upper portion 80a is the portion of tank 80 positioned on the side of the main body 4, and the lower portion 80b is the portion of tank 80 positioned on the side of the work machine main body 81. The internal space may extend throughout the upper portion 80a and the lower portion 80b.

In the example shown in FIG. 3, the upper portion 80a is generally box-shaped, and the lower portion 80b is generally pyramid-shaped. The lower portion 80b has a tapered shape. The cross-sectional area of the lower portion 80b when cut parallel to a horizontal plane perpendicular to the vertical direction decreases as it approaches the side of the work machine main body 81. The volume of the upper portion 80a may be the same as, larger than, or smaller than the volume of the lower portion 80b.

Since the tank 80 has a tapered shape, even if the multicopter 10 tilts during flight, materials such as liquid agents or granular agents can be kept in the lower portion 80b. This can make it easier to discharge materials inside the tank 80 to the outside from the lower portion 80b.

The tank 80 may be detachably supported by the main body 4. Examples of tank structures and support mechanisms for supporting the tank by the main body are described in detail in Japanese Patent No. 6847703, of which the applicant is the patentee. The entire contents of Japanese Patent No. 6847703 are hereby incorporated by reference.

The work machine main body 81 may include a pump including an intake port and a discharge port, and a spray port 83. Examples of the pump include motor pumps such as water pumps and vacuum pumps. For example, the intake port and discharge port of the pump are connected to the tank 80 and the spray port 83, respectively, through piping. This allows materials contained in the tank 80 to be drawn up by the pump and sprayed from the spray port 83.

The housing 82 is provided on the top surface of the upper portion 80a of the tank 80 as illustrated in FIG. 3. The housing 82 may be configured to house the conveyor 90 so that it is not visible from the outside. The housing 82 may include a winding mechanism that allows the conveyor 90 to be wound up or fed out. With such a housing 82, the conveyor 90 can be housed in the housing 82 when not in use, which may improve the aesthetics of the multicopter. It can also prevent the conveyor 90 from getting entangled with the rotors or main body during flight, which would hinder flight.

The conveyor 90 has elasticity and/or flexibility. In other words, the conveyor 90 may be configured to be flexible and stretchable. Examples of the conveyor 90 include pipes, tubes, and hoses. The conveyor 90 may include a nozzle at least as one component or structural element thereof. In an example embodiment of the present disclosure, the conveyor 90 includes nozzles at both ends, for example. A supply port 91 is provided at the tip of the nozzle at one end, and a filling port 92 is provided at the tip of the nozzle at the other end. Thus, the conveyor 90 includes the supply port 91 and the filling port 92 at both end portions. The conveyor 90, including the nozzle portion of the supply port 91, may be housed in the housing 82 so that it cannot be seen from the outside when not in use.

On the top surface of the upper portion 80a of the tank 80, as illustrated in FIG. 4, a connector 88 is provided to connect to the conveyor 90. In the example shown in FIG. 3, the connector 88 is covered by the housing 82 and is not visible. By inserting the filling port 92 of the conveyor 90 into the connector 88, the connection between the tank 80 and the conveyor 90 is secured. Thus, the conveyor 90 may be connected to the upper portion 80a of the tank 80. However, the connection location of the conveyor 90 is not limited to the top surface of the upper portion 80a. For example, the conveyor 90 may be connected to the side surface of the upper portion 80a. In this case, a mechanism such as a check valve is needed to prevent backflow of materials from the tank 80 to the supply port 91 side of the conveyor 90. In other words, the conveyor 90 may further include a check valve.

The multicopter 10 according to an example embodiment of the present disclosure may further include, as shown in FIG. 5, a suction mechanism 85 connected between the conveyor 90 and the tank 80 to draw up materials from a supply station 70 to the tank 80 through the conveyor 90. In the illustrated example, the conveyor 90 directly or indirectly connects a supply station 70 to supply materials to the tank 80, and transports materials from the supply station 70 to the tank. The supply station 70 is indirectly connected to the tank 80 through the conveyor 90 via the suction mechanism 85. However, the supply station 70 may be directly connected to the tank 80 through the conveyor 90 without going through the suction mechanism 85. Examples of the suction mechanism 85 include motor pumps such as water pumps, vacuum pumps, and fuel pumps. Specifically, if the material is a liquid agent or water, an example of the suction mechanism 85 is a water pump. If the material is a granular agent, an example of the suction mechanism 85 is a vacuum pump. If the material is fuel, an example of the suction mechanism 85 is a fuel pump. If the suction mechanism 85 is, for example, a water pump or vacuum pump, it may be provided in the work machine main body 81 as described above. If the suction mechanism 85 is a fuel pump, it may be provided in the main body 4.

A pump, which is an example of the suction mechanism 85, includes an intake port and a discharge port. For example, the intake port of the pump is connected to the filling port 92 of the conveyor 90, and the discharge port of the pump is connected to the tank 80 through piping. The suction mechanism 85 may operate under the control of the controller 4a. This enables materials contained in the supply station 70 to be drawn up by the pump and filled into the tank 80 of the multicopter 10 through the conveyor 90. The suction mechanism 85 with this function may be provided in the supply station 70 rather than in the multicopter 10.

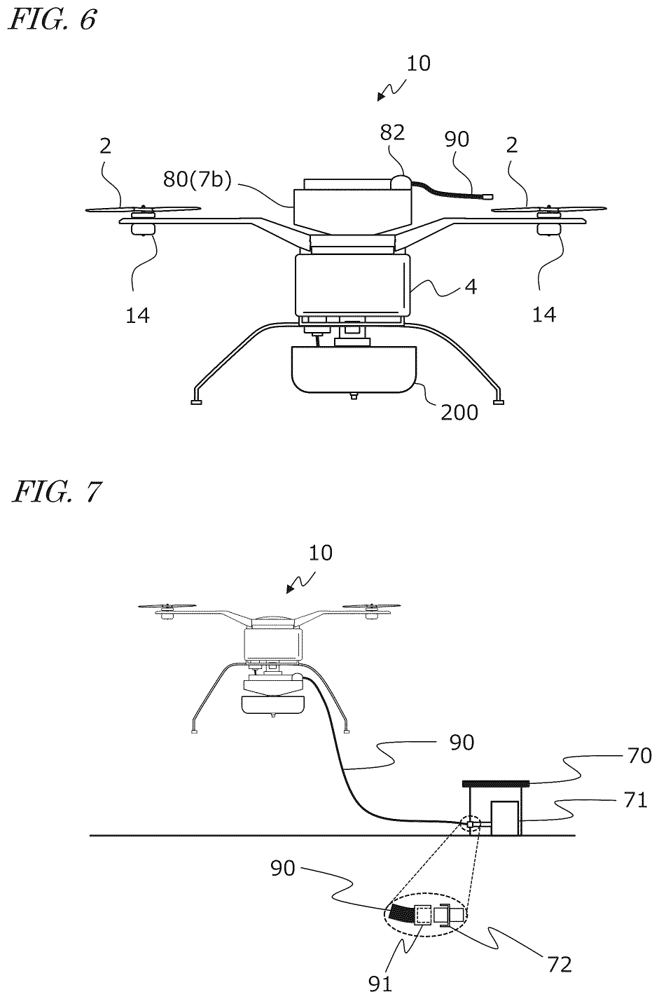

FIG. 6 is a side view schematically showing another example of a basic configuration of multicopter 10 including the tank 80 and conveyor 90. The multicopter 10 illustrated in FIG. 6 differs from the multicopter 10 illustrated in FIG. 3 in that the tank 80 is located above the main body 4. In the example shown in FIG. 6, the multicopter 10 includes an internal combustion engine 7a. Specifically, the multicopter 10 includes the second rotation driver 3B, the third rotation driver 3C, or the fourth rotation driver 3D shown in FIG. 1A. When the multicopter 10 includes an internal combustion engine 7a, the tank 80 may function as a fuel tank 7b that accommodates fuel as the material. A fuel pump is provided in the main body 4, and fuel is supplied from the fuel tank 7b to the internal combustion engine 7a by the fuel pump.

FIG. 7 is a diagram schematically showing a multicopter 10 connected to a supply station 70 by a conveyor 90. The supply station 70 includes a housing 71 for housing materials and a connection port 72 connected to the housing 71 through piping. The connection port 72 includes a nozzle. The supply station 70 may be installed at a specific site or may be mounted on a moving vehicle such as a truck to function as a mobile station. When the supply port 91 of the conveyor 90 is inserted into the connection port 72, the housing 71 of the supply station 70 and the tank 80 of the multicopter 10 are connected through the conveyor 90. Materials injected from the connection port 72 to the supply port 91 are supplied to the tank 80 of the multicopter 10 through the conveyor 90. Examples of the supply station are described in detail in Japanese Patent Application Publication No. 2021-75277. The entire contents of Japanese Patent Application Publication No. 2021-75277 are hereby incorporated by reference.

An operator performing the material filling inserts the supply port 91 of the conveyor 90 of the multicopter 10 into the connection port 72 before the material filling begins. The controller 4a of the multicopter 10 can control the winding mechanism to feed out the conveyor 90 from the winding mechanism. For example, the operator may perform remote operation from the ground using a remote device such as a laptop or tablet terminal, and send a feed-out command from the remote device to the controller 4a of the multicopter 10. When the multicopter 10 is hovering, the controller 4a can pull out the conveyor 90 from the housing 82 and drop it to the ground by controlling the winding mechanism in response to that command. After the material filling is completed, the operator may again use the remote device to perform remote operation from the ground, and send a winding command from the remote device to the controller 4a of the multicopter 10. The controller 4a can wind up the conveyor 90 to house it in the housing 82 by controlling the winding mechanism in response to that command.

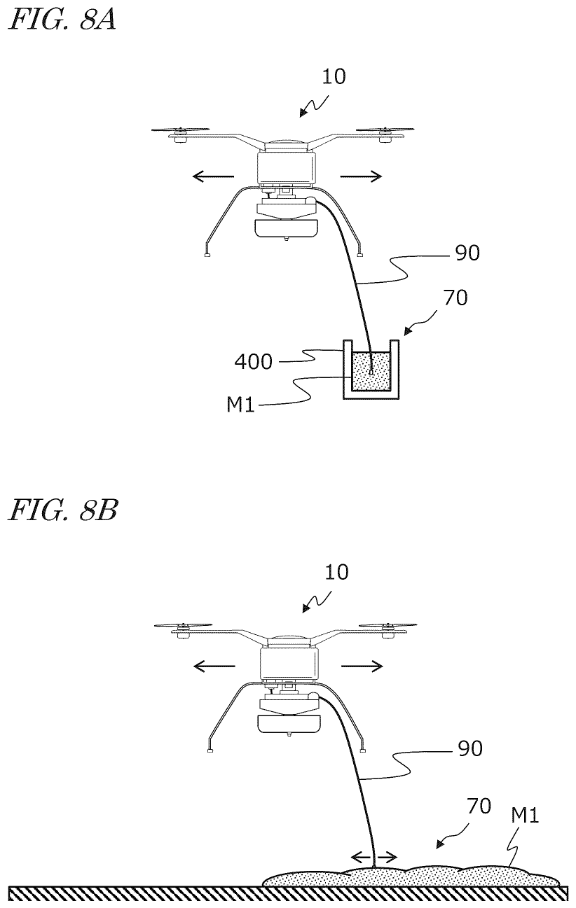

FIG. 8A is a schematic diagram showing a multicopter 10 replenishing materials while hovering. The controller 4a of the multicopter 10 may be configured or programmed to control the operation of the plurality of rotors to make the main body 4 (or the multicopter 10) hover when replenishing materials. As shown in FIG. 8A, when the multicopter 10 is replenishing material M1 contained in a container 400, the controller 4a may be configured or programmed to control the flight of the main body 4 to approach the vicinity of the supply station 70. When the multicopter 10 reaches the vicinity of the supply station 70, the controller 4a is configured or programmed to control the attitude and position of the main body 4 so that the tip end of the conveyor 90 (the supply port 91 shown in FIG. 3) enters the container 400. When the tip end of the conveyor 90 enters the container 400, the controller 4a activates the suction mechanism 85 and starts sucking material M1 from inside the container 400. During the suction of material M1 by the suction mechanism 85, the controller 4a maintains the attitude of the multicopter 10 by controlling the operation of the plurality of rotors to continue hovering the main body 4.

The position information of the location of the supply station 70 may be obtained from one or more servers (computers) or terminal devices (including portable and fixed types) connected to the communication device 4c, or it may be obtained from map data stored in a storage device 37 to be described later. The determination of whether the main body 4 (or the multicopter 10) has reached the supply station 70 can be made based on the result of positioning by a positioning device such as a GNSS receiver. For example, the controller 4a refers to the position information obtained by the positioning device and the position information of the supply station 70, and determines that the main body 4 has reached the supply station 70 if the distance between the main body 4 and the supply station 70 is within a predetermined range. On the other hand, if the distance between them is outside the predetermined range, the controller 4a determines that the main body 4 has not reached the supply station 70. Alternatively, the controller 4a may compare the environmental information indicated by sensing data obtained from sensing devices such as imaging devices or laser sensors that sense the surroundings of the main body 4 with the environmental information of the supply station 70 stored in the storage device 37, and determine whether it has reached the supply station 70 by matching the two. In such an example, the positioning device or sensing device is mounted on the main body 4.

With such control, the multicopter 10 can smoothly perform replenishment using the conveyor 90 by maintaining the attitude of the multicopter 10 during replenishment.

Alternatively, if the conveyor 90 includes a nozzle, the controller 4a may be configured or programmed to control the operation of the plurality of rotors so that the nozzle is positioned near the material to be supplied when supplying material M1 to the tank 80.

FIG. 8B is a schematic diagram showing another way the multicopter 10 replenishes materials while hovering. In the example shown in FIG. 8B, the material M1 is placed on the ground. A source of materials in such a state is also an example of a supply station 70. Similar to FIG. 8A, the controller 4a is configured or programmed to control the flight of the main body 4 to make the multicopter 10 approach the vicinity of the supply station 70. When the multicopter 10 reaches the vicinity of the supply station 70, the controller 4a brings the tip end of the nozzle (the supply port 91 shown in FIG. 3) close to the material M1. The controller 4a activates the suction mechanism 85 and draws up the material M1 from inside the container 400. During the suction of material M1 by the suction mechanism 85, the controller 4a controls the operation of the plurality of rotors so that the main body 4 (or the multicopter 10) is positioned near the material M1. For example, the controller 4a obtains the positional relationship between the tip of the nozzle and the material M1 based on sensing data acquired by the sensing device. The controller 4a may be configured or programmed to control the height, position, and attitude of the main body 4 so that the tip of the nozzle is positioned near the material M1 based on the obtained positional relationship.

With such control, the multicopter 10 can bring the supply port 91 of the conveyor 90 close to the material and smoothly perform replenishment.

The multicopters according to example embodiments of the present disclosure is not limited to a quad-type multicopter but may be, for example, a hexa-type multicopter (hexacopter) including six rotors, or an octo-type multicopter (octocopter) including eight rotors. The controller 4a described above may be configured or programmed to enable autonomous flight of the multicopter. In that case, the multicopter is capable of flying autonomously along a pre-determined flight path.

According to the multicopters of example embodiments of the present disclosure, it is possible to pull out the conveyor from the housing and connect it to the supply station only when filling or replenishing materials to the tank included in the multicopter is necessary. When filling or replenishing materials is not necessary, the conveyor can be housed in the housing to prevent the conveyor from hindering flight, and furthermore, the aesthetics of the multicopter may be improved. In this way, it becomes possible to smoothly fill or replenish liquid agents such as herbicides or insecticides, and fuels from the supply station to the multicopter.

The controllers 4a in example embodiments of the present disclosure may be implemented by a digital computer systems configured or programmed to execute the processes described above.

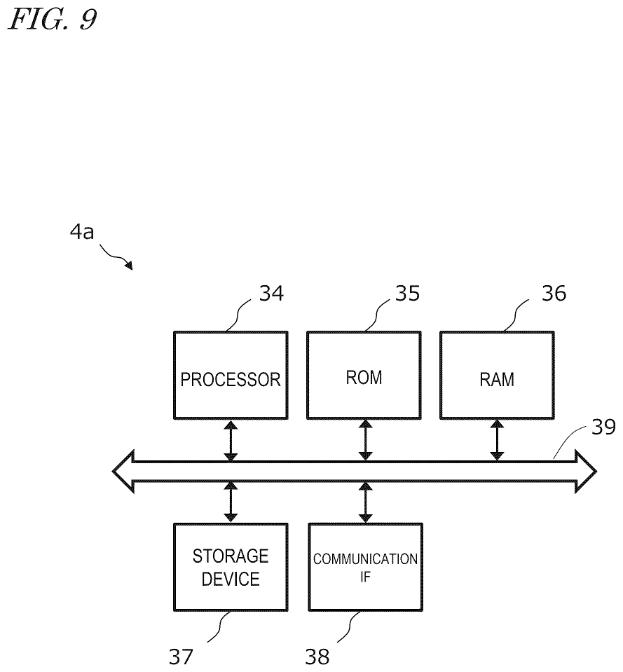

FIG. 9 is a block diagram showing an example of hardware configuration of the controller 4a. The controller 4a includes a processor 34, a ROM (Read Only Memory) 35, a RAM (Random Access Memory) 36, a storage device 37, and a communication I/F 38. These components are interconnected via a bus 39. The bus 39 is, for example, a CAN (Controller Area Network) bus.

The processor 34 is a device including one or more semiconductor integrated circuits (e.g., processors). The processor is also referred to as a central processing unit (CPU) or microprocessor. The processor sequentially executes computer programs stored in the ROM 35 to implement the aforementioned processes. The term processor is broadly interpreted to encompass devices such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (e.g., PROM), rewritable memory (e.g., flash memory), or read-only memory. The ROM 35 stores programs that control the operation of the processor. The ROM 35 need not be a single recording medium but may be a collection of multiple recording media. Some portions of the collection may be removable memory.

The RAM 36 provides a work area for temporarily expanding programs stored in the ROM 35 during boot-up. The RAM 36 need not be a single recording medium but may be a collection of multiple recording media.

The communication I/F 38 is an interface for communication between the controller 4a and other electronic components or electronic control units (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, flight path data, and various sensor data acquired by the multicopter 10 during flight.

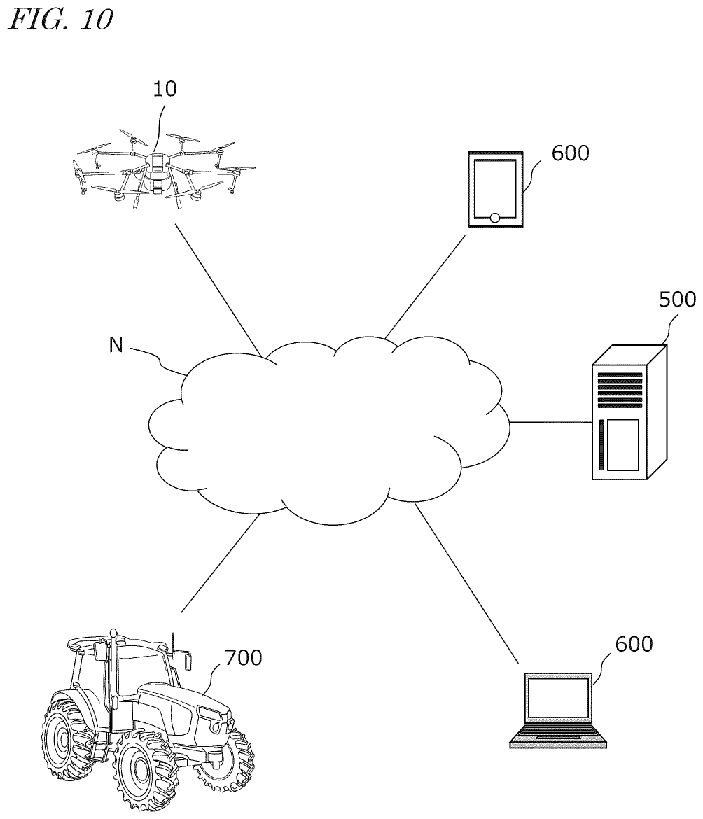

Note that, as mentioned earlier, the controller 4a may be configured or programmed to include, for example, a flight controller such as a flight controller and a higher-level computer (companion computer). The companion computer may execute the processes for implementing material replenishment described with reference to FIG. 8A or FIG. 8B, and provide flight-related commands to the flight controller based on the results of those processes. Additionally, some or all of the functions of electronic equipment such as the controller 4a or companion computer mounted on the multicopter 10 may be implemented by one or more servers (computers) 500 or terminal devices (including portable and fixed types) 600 connected to the communication device 4c of the multicopter 10 via a communication network N, as shown in FIG. 10. An agricultural machine 700 such as a tractor may be connected to this communication network N, and communication may be performed between the multicopter 10 and the agricultural machine 700. Through the communication network N, a portion of the data used for processing by the controller 4a and control signals for the multicopter 10 may be provided to the multicopter 10 from the agricultural machine 700.

Systems providing various functions in the example embodiments can also be attached later to multicopters that do not have those functions. Such systems may be manufactured and sold independently of the multicopter. Computer programs used in such systems may also be manufactured and sold independently of the multicopter. Computer programs may be provided, for example, stored on a non-transitory computer-readable storage medium. Computer programs may also be provided through downloads via telecommunications lines (e.g., the Internet).

Unmanned aerial vehicles according to example embodiments of the present disclosure may be widely utilized not only for aerial photography, surveying, logistics, and agricultural spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising:
a plurality of rotors;
a main body supporting the plurality of rotors;
a tank that accommodates agricultural materials; and
a conveyor provided on the tank to transport the agricultural materials toward the tank; wherein
the conveyor has elasticity and/or flexibility.

2. The unmanned aerial vehicle according to claim 1, wherein
the tank includes an upper portion and a lower portion;
the lower portion has a tapered shape; and
the conveyor is connected to the upper portion.

3. The unmanned aerial vehicle according to claim 1, wherein the tank is provided above or below the main body.

4. The unmanned aerial vehicle according to claim 1, further comprising a suction mechanism connected between the conveyor and the tank to draw up the agricultural materials from the supply station to the tank through the conveyor.

5. The unmanned aerial vehicle according to claim 1, wherein the conveyor includes a nozzle.

6. The unmanned aerial vehicle according to claim 1, further comprising a housing that houses the conveyor so that the conveyor is not visible from the outside.

7. The unmanned aerial vehicle according to claim 1, further comprising a controller configured or programmed to control operation of the plurality of rotors; wherein
when the conveyor is transporting the agricultural materials toward the tank, the controller is configured or programmed to control the operation of the plurality of rotors so that the main body hovers.

8. The unmanned aerial vehicle according to claim 1, further comprising a controller configured or programmed to control operation of the plurality of rotors; wherein:
the conveyor includes a nozzle; and
when supplying the agricultural materials to the tank, the controller is configured or programmed to control the operation of the plurality of rotors so that the nozzle is positioned at or adjacent to the agricultural materials to be supplied.
